(19) United States
(12) Patent Application Publication
(10) Pub. No.: US 2024/0421405 A1
(43) Pub. Date: Dec. 19, 2024

(54) Battery-Powered Unit, System and Method

(71) Applicant: Andreas Stihl AG & Co. KG, Waiblingen (DE)

(72) Inventors: Marc Olivan, Stuttgart (DE); Lukas Solf, Reichenbach an der Fils (DE)

(21) Appl. No.: 18/743,253

(22) Filed: Jun. 14, 2024

(30) Foreign Application Priority Data
Jun. 16, 2023 (DE) 10 2023 115 798.1

(51) Int. Cl. H01M 50/247; H01M 50/264

(52) U.S. Cl. CPC H01M 50/247; H01M 50/264; H01M 2220/30

(57) ABSTRACT

A battery-powered unit includes a battery-bay housing with a battery bay for receiving a battery pack in an interchangeable manner; an arresting lever for releasably fixing a battery pack received in the battery bay; at least one axial portion which extends along a pivot axis of the battery-powered unit and carries the arresting lever; and at least one snap-fit device, which is fixed to the battery-bay housing and into which the axial portion can be snap-fitted such that, once the axial portion has been snap-fitted, the arresting lever is mounted such that it can be pivoted about the pivot axis relative to the battery-bay housing.

### CROSS REFERENCE TO RELATED APPLICATION

This application claims priority under 35 U.S.C. § 119 from German Patent Application No. 10 2023 115 798.1, filed Jun. 16, 2023, the entire disclosure of which is herein expressly incorporated by reference.

### BACKGROUND AND SUMMARY

The invention relates to a battery-powered unit, in particular in the form of a working tool or charger or adapter or transporting unit. The invention also relates to a system having such a battery-powered unit. The invention further relates to a method for assembling such a battery-powered unit.

The present invention addresses the problem of creating a battery-powered unit, in particular a working tool or charger or adapter or transporting unit, and also a system having such a battery-powered unit, and also a method for assembling such a battery-powered unit, which have improved properties.

This problem is solved by the subjects of the independent claims. Preferred embodiments form the subject matter of the dependent claims.

A battery-powered unit according to the invention has a battery-bay housing with a battery bay for receiving a battery pack in an interchangeable manner. The battery-powered unit can be a working tool or a charger or an adapter or a transporting unit. The battery-powered unit here has an arresting lever for releasably fixing a battery pack received in the battery bay. The battery-powered unit also has at least one axial portion which extends along a pivot axis of the battery-powered unit, wherein the axial portion carries the arresting lever. Moreover, the battery-powered unit has at least one snap-fit device, which is fixed to the battery-bay housing and into which the axial portion can be snap-fitted such that, once the axial portion has been snap-fitted, the arresting lever is mounted such that it can be pivoted about the pivot axis relative to the battery-bay housing. The snap-fit device is therefore designed such that the axial portion can be snap-fitted, in particular in the snap-fit device, so that, once the axial portion has been snap-fitted, the arresting lever is mounted such that it can be pivoted about the pivot axis relative to the battery-bay housing. The snap-fit device advantageously allows pivotable mounting of the axial portion and/or of the arresting lever by means of a single bearing component of the battery-powered unit, the bearing component being formed by the snap-fit device. It is possible here for the snap-fit device and the axial portion to be coordinated with one another such that the axial portion can automatically disengage, in particular if, after a user has accidentally dropped it, the battery-powered unit, accelerated by gravity, strikes against a ground surface or floor surface.

The battery-powered unit designed in the form of a working tool can be guided along a ground surface or floor surface and/or be hand-operated, in particular hand-held, and/or worn on the back and/or can be a gardening, forestry, soil-working and/or construction unit. In particular, the working tool can be a saw, in particular a chainsaw, or a pruner, or a hedge trimmer, or a hedge cutter, or a wood cutter, or pruning shears, an angle grinder or a blower, or a leaf blower, or a vacuum cleaner, or a leaf vacuum, or a cleaning appliance, or a high-pressure cleaner, or a sweeper, or a sweeper roller, or a sweeping brush, or a lawnmower, or a grass trimmer, or a brush cutter, or a scarifier. Additionally or alternatively, the working tool can have a working implement and/or an in particular electric drive motor, in particular for driving the working implement. The drive motor can be supplied with electrical energy from the battery pack.

The battery-powered unit designed in the form of a charger can have a grid connection for electrical connection to an electrical energy source, for example to an electrical supply grid. The charger can be used to charge the received battery pack with electrical energy.

The battery-bay housing of the battery-powered unit designed in the form of an adapter can be configured to be received by a complementary receiving arrangement of a superordinate battery-powered unit. In this case, the battery-bay housing can be received by the receiving arrangement when the battery pack has been received in the battery bay of the adapter. The battery pack can be interchangeable when the battery-bay housing of the adapter has been received by the receiving arrangement of the superordinate battery-powered unit and/or when the battery-bay housing has been removed from the receiving arrangement. By means of the adapter, the battery pack can be connected to the receiving arrangement of the superordinate battery-powered unit. To this extent, the battery-bay housing of the adapter can function as a battery adapter for coupling the battery pack to the superordinate battery-powered unit.

The battery-powered unit designed in the form of a transporting unit can be designed for transporting the battery pack. The transporting unit can be configured for, in particular releasable, electrical connection of an electric load to the received battery pack. In this case, the transporting unit can have at least one electrical output connection for connecting the electric load, wherein the output connection can be or is electrically connected to the received battery pack, in order for the connected load to be supplied with electrical energy from the received battery pack. Alternatively, the transporting unit can be configured to insulate the received battery pack electrically.

The battery-powered unit, designed in particular in the form of a working tool or charger or adapter or transporting unit, can be designed to be worn on the back. If the battery-powered unit is designed to be worn on the back, at least the battery-bay housing of the battery-powered unit can be configured to be worn on a user's back. For this purpose, the battery-powered unit can comprise a harness, which is designed to allow a user to wear the battery-bay housing. The harness can have at least one shoulder strap and/or waist strap and/or chest strap.

The battery pack can be designed for, in particular tool-free and/or non-destructive, user-releasable mechanical connection to the battery-powered unit and/or to be interchangeable by the user or removable by the user, in particular from or out of the battery-powered unit. In particular, the battery pack can be designed to be carried by the battery-powered unit. The battery pack can have multiple battery cells. In particular, the battery cells can be arranged in a pack housing of the battery pack. Additionally or alternatively, the battery cells can each be individually rechargeable electrochemical-based electrical-energy storage elements. Further additionally or alternatively, the battery cells can be lithium-ion battery cells. Further additionally or alternatively, the battery cells can be identical, in particular of the same type and/or construction. Further additionally or alternatively, a cell voltage, in particular a respective cell voltage, in particular a nominal cell voltage, of one of the battery cells, in particular a respective one of the battery cells, can be at least 2 V, in particular at least 3.6 V, and/or at most 5 V, in particular at most 4.2 V. Further additionally or alternatively, the battery cells can be round cells, prismatic cells or pouch cells. The battery cells can be designed to supply the battery-powered unit with electrical drive power and/or can be supplied with electrical charging power by means of the battery-powered unit.

The term “configured” can be used synonymously with the term “designed”.

The term “comprises” can be used synonymously with the term “has”.

“Arranged” can denote arranged, in particular fastened, in three dimensions and/or in a fixed state, in particular at a fixed location. Additionally or alternatively, the term “positioned” can be used synonymously with the term “arranged”.

In one configuration of the invention, the snap-fit device, in particular in the form of an integral bearing clip, is materially bonded to the battery-bay housing. In other words: The snap-fit device can be formed integrally on the battery-bay housing. The snap-fit device and the battery-bay housing can therefore be formed in one piece. Alternatively or additionally, the axial portion is materially bonded to the arresting lever. The axial portion and the arresting lever can therefore be formed integrally on one another. In other words: The axial portion and the arresting lever can be formed in one piece. The material bonding between the snap-fit device and the battery-bay housing and also—alternatively or additionally—the material bonding between the axial portion and the arresting lever can reduce the number of parts and therefore, as a result, can simplify the assembly of the battery-powered unit.

In a further configuration of the invention, the snap-fit device has a C-shaped bearing surface. The bearing surface here in particular only partially encloses a bearing space which is coordinated with the axial portion and is intended for receiving the axial portion with snap-fitting action. The bearing space and the axial portion can be designed to complement one another, in particular in terms of diameter. The bearing surface has mutually opposite end regions, which together delimit a snap-fit aperture of the snap-fit device, the aperture opening the bearing space radially. The snap-fit aperture is narrowed relative to the bearing space such that the axial portion can be snap-fitted into the bearing space. In particular, the axial portion can be snap-fitted into the bearing space with the snap-fit aperture being elastically widened in the process and also—alternatively or additionally—with the axial portion being elastically deformed in the process.

The axial portion expediently has an external diameter of 5 mm to 10 mm, in particular 7 mm. A distance between the end regions, which can delimit the snap-fit aperture, can be 75% to 85% of the external diameter of the axial portion. The bearing space can be coordinated with the axial portion, in particular in a complementary manner, such that an amount of radial play of 0.1 to 0.5 mm, for example 0.3 mm, is present between an internal diameter of the bearing surface and the snap-fitted axial portion. This amount of play can ensure that the axial portion is able to pivot relative to the battery-bay housing.

In a further configuration of the invention, once the axial portion has been snap-fitted, the bearing surface of the snap-fit device in particular only partially extends around the pivot axis, within a bearing-surface angle with its vertex at the pivot axis, in particular between end regions of the bearing surface. In particular, the bearing-surface angle is greater than 180° and smaller than 360°, in particular greater than 200° and smaller than 300°, in particular greater than 260° and smaller than 280°. A snap-fit force to be applied radially to the axial portion in order for the axial portion to be snap-fitted into the snap-fit device and also a disengagement force to be applied to the axial portion in order for the axial portion to be disengaged from the snap-fit device can be dependent, in particular essentially, on the bearing-surface angle.

In a further configuration of the invention, the battery bay is open along a receiving direction of the battery-powered unit. The battery pack can be received by and/or in the battery bay in an interchangeable manner along the receiving direction. The axial portion can be snap-fitted, along a snap-fit direction of the battery-powered unit, into the bearing space of the snap-fit device through the snap-fit aperture of the snap-fit device, the aperture opening the bearing space radially. The snap-fit direction is positioned at a snap-fit angle of the battery-powered unit in relation to the receiving direction. In particular, the snap-fit angle is 60° to 80°, preferably 65° to 75°. In particular, the snap-fit angle can be such that, when the arresting lever is actuated as intended, disengagement of the snap-fitted axial portion is more difficult, or even avoided, but, once the battery-powered unit dropped by the user has struck against the ground surface or floor surface, disengagement can take place automatically, so as to avoid the situation where the snap-fit device and/or the axial portion and/or the arresting lever and/or the battery-bay housing are/is subjected to pronounced loading. It is possible here for the elastic deformability of the snap-fit device and/or of the axial portion to give rise to friction during disengagement action, and this friction can result in at least some of the impact energy of the dropped battery-powered unit being dissipated, in particular such that damage is avoided.

In a further configuration of the invention, the battery-bay housing has at least one placement surface for the placement of the arresting lever in the form of an assembly aid for the snap-fitting of the axial portion. In particular, the at least one placement surface extends essentially tangentially in relation to the bearing surface of the snap-fit device. Alternatively or additionally, the at least one placement surface can be positioned at the snap-fit angle of the battery-powered unit in relation to the receiving direction of the battery-powered unit.

In a further configuration of the invention, the battery-powered unit has a counter-surface, which is located opposite the placement surface as seen in a direction transverse to the pivot axis. Together with the placement surface, the counter-surface in particular only partially delimits a pre-positioning space of the battery-powered unit for the pre-positioning of the axial portion which is to be snap-fitted. The pre-positioning space merges into the bearing space of the snap-fit device at the snap-fit aperture of the snap-fit device. The pre-positioning space is tapered in the direction of the snap-fit aperture such that, once the axial portion has been pre-positioned in the pre-positioning space, in particular not snap-fitted, actuating-action, i.e. in particular intended, pivoting of the arresting lever about the pivot axis makes it possible for the axial portion to be snap-fitted into the bearing space through the snap-fit aperture.

In a further configuration of the invention, the arresting lever has an actuating end portion for actuation of the arresting lever, in particular by a user, and an engagement end portion for releasable fixing engagement on the received battery pack. The battery pack can be equipped with an engagement contour complementary to the engagement end portion. In particular, the engagement contour of the battery pack can have one or more latching protrusions, which are arranged at a distance from one another in particular along the receiving direction. The axial portion is arranged between the actuating end portion and the engagement end portion. The actuating end portion has a protrusion, which protrudes transversely in relation to the pivot axis. The protrusion is designed so that, when the axial portion is to be snap-fitted, the protrusion fits on an edge of the placement surface that is directed away from the snap-fit device. In particular, the protrusion can be fitted on the edge when the axial portion has been pre-positioned in the pre-positioning space.

In a further configuration of the invention, the battery-powered unit has a stop device for fastening on the battery-bay housing. The stop device can therefore be fastened on the battery-bay housing. In a state in which the stop device has been fastened on the battery-bay housing, the stop device separates the bearing space of the snap-fit device from the pre-positioning space of the battery-powered unit. In other words: If the stop device has been fastened on the battery-bay housing, the bearing space has been separated from the pre-positioning space by means of the stop device. In the fastened state of the stop device, the bearing space has been separated from the pre-positioning space by means of the stop device such that the stop device blocks disengagement of the snap-fitted axial portion into the pre-positioning space. In this way, the snap-fitted axial portion can be held particularly reliably in the bearing space. The stop device can secure the axial portion and/or the arresting lever against being lost.

In a further configuration of the invention, in its state in which it has been fastened on the battery-bay housing, the stop device is arranged at a radial distance from the snap-fitted axial portion. In particular, this radial distance between the stop device and the snap-fitted axial portion is 0.2 mm to 5 mm, in particular 0.3 mm to 0.6 mm. This radial distance can provide a friction distance for the at least partial dissipation and/or absorption of the impact energy of the dropped battery-powered unit.

In a further configuration of the invention, the stop device is an integral constituent part of a hood-like cover of the battery-powered unit. The hood-like cover can be fastened, in particular directly or indirectly, on the battery-bay housing in particular in order to extend the length of the battery bay.

In a further configuration of the invention, once the axial portion has been snap-fitted, the arresting lever has a fixing position for fixing engagement on the received battery pack and a release position for releasing the fixing engagement. Between the fixing position and the release position, the arresting lever can be pivoted about the pivot axis relative to the battery-bay housing. In particular, the arresting lever is spring-prestressed into its fixing position. The arresting lever can be spring-prestressed into its fixing position such that, when the battery pack is being received in the battery bay, the arresting lever latches automatically, i.e. in particular without actuation by the user, on the received battery pack, in order to establish the fixing engagement.

The battery-powered unit expediently has two, in particular stub-like, axial portions, which, being located opposite one another along the pivot axis, flank the arresting lever. It is possible here for the battery-powered unit to have two snap-fit devices, each designed so that an associated axial portion can be snap-fitted into them. When the axial portions have been snap-fitted, the arresting lever can be arranged along the pivot axis between the two snap-fit devices such that the snap-fit devices delimit an axial position of the arresting lever relative to the battery-bay housing.

A system according to the invention has a battery-operated unit according to the invention as described above. To this extent, the aforementioned advantages of the battery-powered unit according to the invention can also be transferred to the system according to the invention having such a battery-powered unit. In addition, the system has a battery pack for being received in the battery bay in an interchangeable manner.

A method according to the invention serves to assemble a battery-powered unit configured according to the invention, as described above. To this extent, it is possible to provide for utilization of aforementioned advantages of the battery-powered unit configured according to the invention by means of the method. The method has a step a), according to which the battery-bay housing is provided, wherein the battery-bay housing is connected to the snap-fit device. The method also has a step b), according to which the axial portion is provided, wherein the axial portion carries the arresting lever. The method moreover comprises a step c), according to which the arresting lever is placed on the placement surface and the axial portion is pre-positioned in the pre-positioning space. The method additionally comprises a step d), according to which the arresting lever is pivoted, with actuating action, away from the placement surface, in particular about the pivot axis, such that the axial portion is received, through the snap-fit aperture, into the bearing space, in order for the axial portion to be snap-fitted. In this way, the battery-powered unit can be assembled particularly straightforwardly, quickly and therefore cost-effectively.

In one configuration of the invention, in particular of the method, at a point in time after step d) has been carried out, the stop device of the battery-powered unit is fastened on the battery-bay housing such that disengagement of the snap-fitted axial portion into the pre-positioning space is blocked by means of the stop device.

Further advantages and features of the invention can be gathered from the claims and also from the following description of preferred exemplary embodiments of the invention, which are illustrated by the drawings. Reference signs that are the same denote components that are the same or similar or have the same function.

Of course, the features mentioned above and those which are still to be explained hereinbelow can be used not only in the respectively given combination but also in other combinations, or on their own, without departing from the scope of the present invention.

### BRIEF DESCRIPTION OF THE DRAWINGS

FIG. 1 is a schematic perspective illustration of one embodiment of a system according to the invention having one embodiment of a battery-powered unit according to the invention, wherein the battery-powered unit has been assembled by a method according to the invention;

FIG. 2 is a schematic lateral illustration of a further embodiment of a battery-powered unit according to the invention which has been assembled by means of a method according to the invention;

FIG. 3 is a schematic sectional illustration of a further embodiment of the system according to the invention;

FIG. 4 is a schematic exploded illustration, in perspective, of the system according to FIG. 3;

FIG. 5 is a schematic sectional illustration of a detail of a further embodiment of the battery-powered unit according to the invention in the form of a snapshot taken while the method according to the invention for assembling the battery-powered unit is being carried out;

FIG. 6 is a schematic sectional illustration of a detail of the battery-powered unit according to FIG. 5 in the form of a further snapshot taken while the method according to the invention is being carried out;

FIG. 7 is a schematic sectional illustration of a detail of the battery-powered unit according to FIGS. 5 and 6 in the form of a further snapshot taken while the method according to the invention is being carried out;

FIG. 8 is a schematic lateral illustration of the battery-powered unit according to FIGS. 5 to 7, in the form of the snapshot according to FIG. 6, while the method according to the invention is being carried out; and

FIG. 9 is a schematic lateral view of a detail of a snap-fit device of the battery-powered unit according to FIGS. 5 to 8.

### DETAILED DESCRIPTION OF THE DRAWINGS

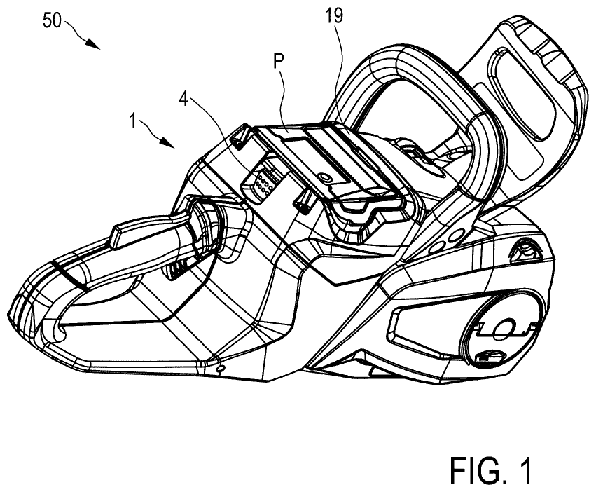

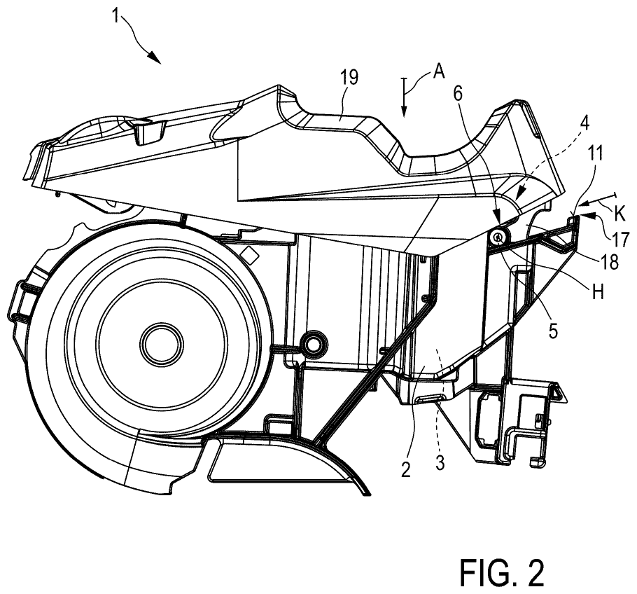

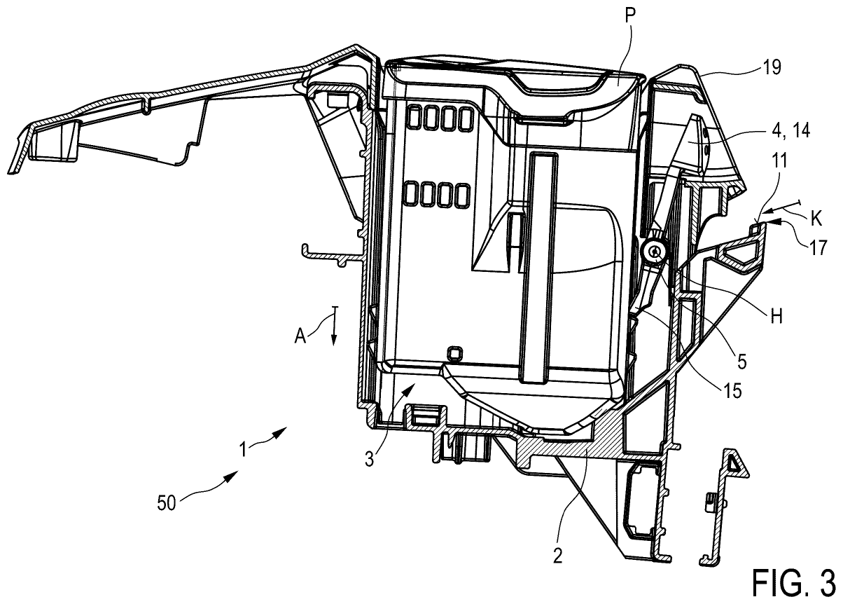

A system 50 has a battery-powered unit 1 and also a battery pack P to be received in a battery bay 3 of the battery-powered unit 1 in an interchangeable manner. A battery-powered unit 1 designed in the form of a hand-operated working tool can be seen by way of example in FIGS. 1 and 2. The hand-operated working tool according to FIG. 1 is a chainsaw, in this case—for reasons of clarity—illustrated without a guide bar and without a saw chain. In other embodiments, the battery-powered unit 1, for example according to FIG. 2, can be designed in the form of some other kind of working tool or of a charger or of an adapter for a superordinate battery-powered unit or of a transporting unit.

The battery-powered unit 1 has a battery-bay housing 2. The battery-bay housing 2 has a battery bay 3 for receiving a battery pack P in an interchangeable manner. The battery pack P is not a constituent part of the battery-powered unit 1. In the system 50, the battery pack P can be received in the battery bay 3 and electrically connected to the battery-powered unit 1.

The battery-powered unit 1 has an arresting lever 4 for releasably fixing a battery pack P received in the battery bay 3. The battery-powered unit 1 also has at least one axial portion 5 which extends along a pivot axis H of the battery-powered unit 1 and carries the arresting lever 4. The battery-powered unit 1 further has at least one snap-fit device 6, which is fixed to the battery-bay housing 2 and into which the axial portion 5 can be snap-fitted. The axial portion 5 can be snap-fitted such that, once the axial portion 5 has been snap-fitted, the arresting lever 4 is mounted such that it can be pivoted about the pivot axis H relative to the battery-bay housing 2.

For example, the snap-fit device 6—as is the case here—is materially bonded to the battery-bay housing 2. The snap-fit device 6 can be designed in the form of an integral bearing clip. Alternatively or additionally, the axial portion 5—as is the case here—is materially bonded to the arresting lever 4.

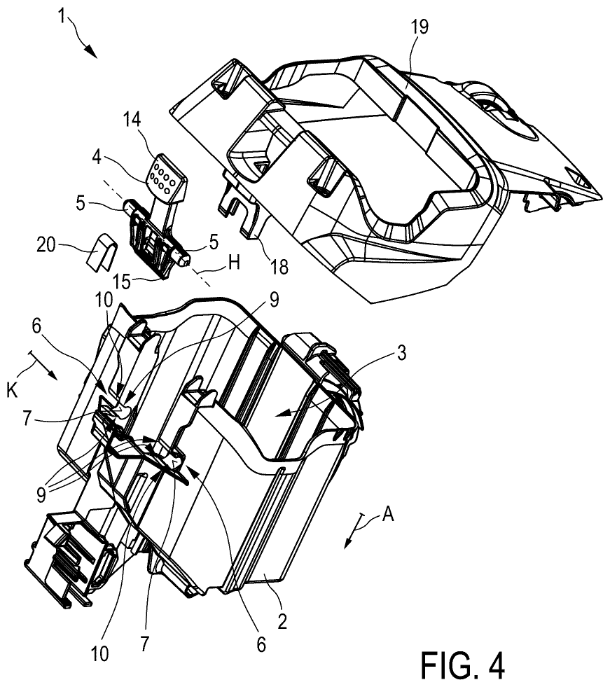

The snap-fit device 6 here has a C-shaped bearing surface 7, c.f. in particular FIG. 4. The bearing surface 7 partially encloses a bearing space 8 which is coordinated, in particular in a complementary manner, with the axial portion 5 and is intended for receiving the axial portion 5 with snap-fitting action. The bearing surface 7 has mutually opposite end regions 9. The end regions 9 together delimit a snap-fit aperture 10 of the snap-fit device 6, the aperture opening the bearing space 8 radially. The snap-fit aperture 10 is narrowed relative to the bearing space 8 such that the axial portion 5 can be snap-fitted into the bearing space 8. For example, the axial portion 5 can be snap-fitted into the bearing space 8 with the snap-fit aperture 10 being elastically widened in the process and also—alternatively or additionally—with the axial portion 5 being elastically deformed in the process.

The axial portion 5 has, for example, an external diameter of 5 mm to 10 mm, in particular 7 mm. A distance between the end regions 9, which can delimit the snap-fit aperture 10, can be 75% to 85% of the external diameter. The bearing space 8 can be coordinated with the axial portion 5 such that an amount of radial play of 0.1 mm to 0.5 mm, in this case 0.3 mm, is present between an internal diameter of the bearing surface 7 and the snap-fitted axial portion 5.

Once the axial portion 5 has been snap-fitted, the bearing surface 7 of the snap-fit device 6 partially extends around the pivot axis H, for example within a bearing-surface angle α with its vertex at the pivot axis H. In particular, the bearing surface 7 extends, within the bearing-surface angle α, between the end regions 9 of the bearing surface 7. The bearing-surface angle α is for example greater than 180° and smaller than 360°, in particular greater than 200° and smaller than 300°, in this case greater than 260° and smaller than 280°.

For example, the battery bay is open along a receiving direction A of the battery-powered unit 1. The battery pack P can be received in the battery bay 3 in an interchangeable manner along the receiving direction A. The axial portion 5 can be snap-fitted, for example along a snap-fit direction K of the battery-powered unit 1, into the bearing space 8 of the snap-fit device 6 through the snap-fit aperture 10 of the snap-fit device 6, the aperture opening the bearing space 8 radially. The snap-fit direction K is positioned for example at a snap-fit angle β of the battery-powered unit 1 in relation to the receiving direction A. The snap-fit angle β is for example 60° to 80°, in this case between 65° and 75°.

Two axial portions 5 of mirror-symmetrical design and two snap-fit devices 6, which are assigned to the axial portions 5, are present here. The two axial portions 5 project, for example opposite one another, from the arresting lever 4.

The battery-bay housing 2 has for example at least one placement surface 11, which serves for the placement of the arresting lever 4 in the form of an assembly aid for the snap-fitting of the axial portion 5. The at least one placement surface 11 here extends essentially tangentially in relation to the bearing surface 8 of the snap-fit device 6. Alternatively or additionally, the at least one placement surface 11—as is the case here—can be positioned at the snap-fit angle β of the battery-powered unit 1 in relation to the receiving direction A of the battery-powered unit 1.

The battery-powered unit 1 here has a counter-surface 12. The counter-surface 12 is located opposite the placement surface 11 as seen in a direction transverse to the pivot axis H, in particular approximately vertically. The counter-surface 12 and the placement surface 11 together partially delimit a pre-positioning space 13 of the battery-powered unit 1 for the pre-positioning of the axial portion 5 which is to be snap-fitted. The pre-positioning space 13 merges into the bearing space 8 of the snap-fit device 6 for example at the snap-fit aperture 10 of the snap-fit device 6. The pre-positioning space 13 here is tapered in the direction of the snap-fit aperture 10 such that, once the axial portion 5 has been pre-positioned in the pre-positioning space 13, actuating-action pivoting of the arresting lever 4 about the pivot axis H makes it possible for the axial portion 5 to be snap-fitted into the bearing space 8 through the snap-fit aperture 10.

For example, the arresting lever 4 has an actuating end portion 14 for its actuation and an engagement end portion 15 for releasable fixing engagement on the received battery pack P. The axial portion 5 here is arranged between the actuating end portion 14 and the engagement end portion 15. The actuating end portion 14 has, for example, a protrusion 16, which protrudes transversely in relation to the pivot axis H. The protrusion 16 here is designed so that, when the axial portion 5 is to be snap-fitted and/or has been pre-positioned, the protrusion 16 fits on an edge 17 of the placement surface 11 that is directed away from the snap-fit device 6.

The battery-powered unit 1 here also has a stop device 18, which can be fastened—in this case is fastened—on the battery-bay housing 2. When it has been fastened on the battery-bay housing 2, the stop device 18 separates the bearing space 8 of the snap-fit device 6 from the pre-positioning space 13 of the battery-powered unit 1 such that the stop device 18 blocks disengagement of the snap-fitted axial portion 5 into the pre-positioning space 13. For example, in its state in which it has been fastened on the battery-bay housing 2, the stop device 18 is arranged at a radial distance from the snap-fitted axial portion 5. The radial distance can be 0.2 mm to 5 mm. Here, this radial distance between the stop device 18 and the snap-fitted axial portion 5 is between 0.3 mm and 0.6 mm.

The stop device 18 here is an integral constituent part of a hood-like cover 19 of the battery-powered unit 1. The hood-like cover 19 can be fastened on the battery-bay housing 2 for example in order to extend the length of the battery bay 3. Accordingly, the hood-like cover 19 can have a through-passage, through which the battery pack P can be introduced into the battery bay 3, and removed from the battery bay 3, along the receiving direction A.

For example, once the axial portion 5 has been snap-fitted, the arresting lever 4 has a fixing position for fixing engagement on the received battery pack P and also a release position for releasing the fixing engagement. For example, between the fixing position and the release position, the arresting lever 4 can be pivoted about the pivot axis H relative to the battery-bay housing 2. For example, the arresting lever 4 is spring-prestressed into its fixing position, in this case by means of a spring element 20 of the battery-powered unit 1. The spring element 20 can be designed—as is the case here—in the form of a leaf spring, in particular in the form of a U-shaped leaf spring. Alternatively, however, other types of spring are also contemplated, for example leg-spring types or the like. The arresting lever 4 can be for example user-actuated, in order to be adjusted from its engagement position into its release position.

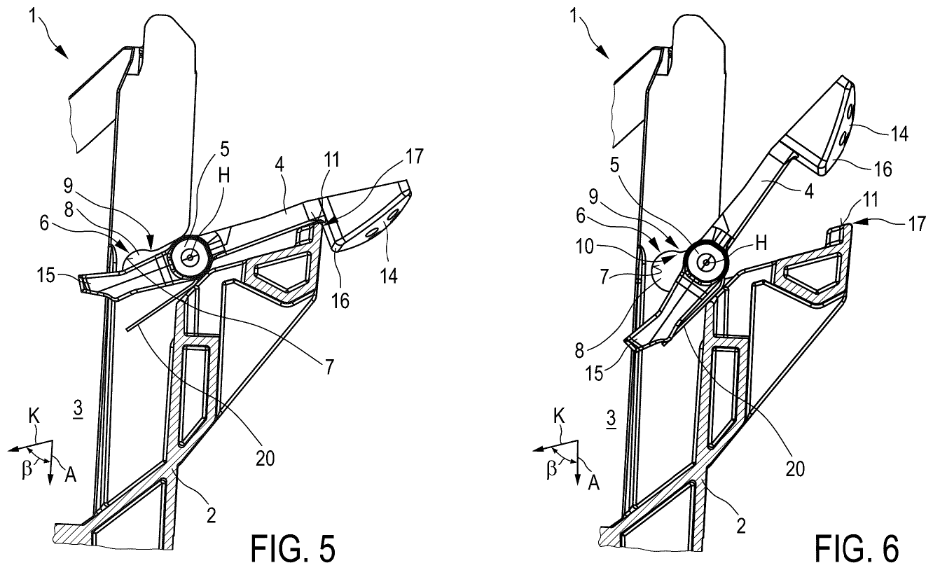

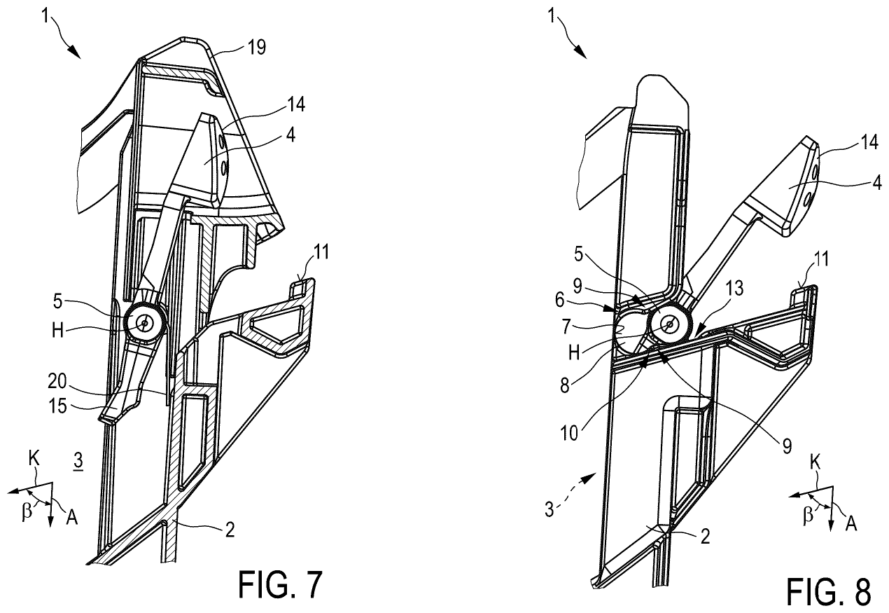

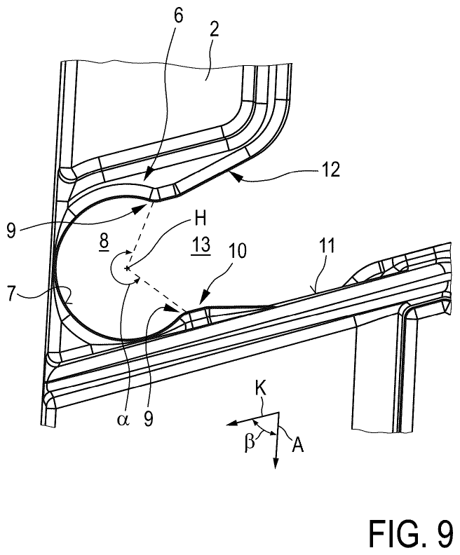

The battery-powered unit 1 here has been assembled by a method according to the invention. The method has a first step a), according to which the battery-bay housing 2 is provided, the housing being connected to the snap-fit device 6. The method also comprises a step b), according to which the axial portion 5 is provided, the axial portion carrying the arresting lever 4. According to a further step c) of the method, the arresting lever 4 is placed on the placement surface 11 and the axial portion 5 is pre-positioned in the pre-positioning space 13, cf. for example FIG. 5. This is followed by a further step d) of the method, according to which the arresting lever 4 is pivoted, with actuating action, away from the placement surface 11, in particular about the pivot axis H, such that the axial portion 5 is received, through the snap-fit aperture 10, into the bearing space 8, in order for the axial portion 5 to be snap-fitted. Step d) can be understood by looking at FIGS. 6 to 8.

For example, at a point in time after step d) has been carried out, the stop device 18 of the battery-powered unit 1 is fastened on the battery-bay housing 2. The stop device 18 can be fastened on the battery-bay housing 2 such that disengagement of the snap-fitted axial portion 5 into the pre-positioning space 13 is blocked by means of the stop device 18.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A battery-powered unit, comprising:
a battery-bay housing with a battery bay for receiving a battery pack in an interchangeable manner;
an arresting lever for releasably fixing the battery pack when received in the battery bay;
at least one axial component portion which extends along a pivot axis of the battery-powered unit and carries the arresting lever; and
at least one snap-fit device, which is fixed to the battery-bay housing and into which the axial portion can be snap-fit such that, once the axial portion has been snap-fit, the arresting lever is mounted so as to be pivotable about the pivot axis relative to the battery-bay housing.

2. The battery-powered unit according to claim 1, wherein
the snap-fit device is materially bonded to the battery-bay housing, and/or
the axial component portion is materially bonded to the arresting lever.

3. The battery-powered unit according to claim 2, wherein the snap-fit device is in the form of an integral bearing clip.

4. The battery-powered unit according to claim 1, wherein
the snap-fit device has a C-shaped bearing surface, wherein the bearing surface partially encloses a bearing space which is coordinated with the axial portion and is intended for receiving the axial portion with a snap-fitting action,
the bearing surface has mutually opposite end regions, which together delimit a snap-fit aperture of the snap-fit device, the aperture opening the bearing space radially, and
the snap-fit aperture is narrowed relative to the bearing space such that the axial portion can be snap-fit radially into the bearing space, with the snap-fit aperture being elastically widened in doing so and/or with the axial portion being elastically deformed in doing so.

5. The battery-powered unit according to claim 1, wherein
once the axial portion has been snap-fit in the snap-fit device, a bearing surface of the snap-fit device partially extends around the pivot axis, within a bearing-surface angle (a) with its vertex at the pivot axis, between end regions of the bearing surface.

6. The battery-powered unit according to claim 5, wherein the bearing-surface angle (α) is greater than 180° and less than 360°.

7. The battery-powered unit according to claim 5, wherein the bearing-surface angle (α) is greater than 200° and less than 300°.

8. The battery-powered unit according to claim 5, wherein the bearing-surface angle (α) is greater than 260° and less than 280°.

9. The battery-powered unit according to claim 1, wherein
the battery bay is open along a receiving direction of the battery-powered unit and the battery pack can be received by the battery bay in an interchangeable manner along the receiving direction,
the axial portion can be snap-fit, along a snap-fit direction of the battery-powered unit, into a bearing space of the snap-fit device through a snap-fit aperture of the snap-fit device, the aperture opening the bearing space radially,
the snap-fit direction is positioned at a snap-fit angle (β) of the battery-powered unit in relation to the receiving direction, and
the snap-fit angle is 60 to 80°.

10. The battery-powered unit according to claim 9, wherein
wherein the snap-fit angle (β) is 65° to 75°.

11. The battery-powered unit according to claim 1, wherein
the battery-bay housing has at least one placement surface for placement of the arresting lever as an assembly aid for the snap-fitting of the axial portion, and
the at least one placement surface extends essentially tangentially in relation to a bearing surface of the snap-fit device and/or the at least one placement surface is positioned at a snap-fit angle of the battery-powered unit in relation to a receiving direction of the battery-powered unit.

12. The battery-powered unit according to claim 11, wherein
the battery-powered unit has a counter-surface, which is located opposite the placement surface as seen in a direction transverse to the pivot axis and which, together with the placement surface, partially delimits a pre-positioning space of the battery-powered unit for pre-positioning of the axial portion which is to be snap-fitted,
the pre-positioning space merges into a bearing space of the snap-fit device at a snap-fit aperture of the snap-fit device,
the pre-positioning space is tapered in the direction of the snap-fit aperture such that, once the axial portion has been pre-positioned in the pre-positioning space, actuating-action pivoting of the arresting lever about the pivot axis allows the axial portion to be snap-fit into the bearing space through the snap-fit aperture.

13. The battery-powered unit according to claim 1, wherein
the arresting lever has an actuating end portion for its actuation and an engagement end portion for releasable fixing engagement on the received battery pack,
the axial portion is arranged between the actuating end portion and the engagement end portion,
the actuating end portion has a protrusion, which protrudes transversely in relation to the pivot axis, and
the protrusion is designed so that, when the axial portion is to be snap-fitted, the protrusion fits on an edge of the placement surface that is directed away from the snap-fit device.

14. The battery-powered unit according to claim 1, wherein
the battery-powered unit has a stop device for fastening on the battery-bay housing, and
in a state in which the stop device has been fastened on the battery-bay housing, the stop device separates a bearing space of the snap-fit device from a pre-positioning space of the battery-powered unit such that the stop device blocks disengagement of the snap-fitted axial portion into the pre-positioning space.

15. The battery-powered unit according to claim 14, wherein
in a state in which the stop device has been fastened on the battery-bay housing, the stop device is arranged at a radial distance from the snap-fitted axial portion,
wherein the distance is 0.2 to 5 mm.

16. The battery-powered unit according to claim 14, wherein
the stop device is an integral constituent part of a hood-shaped cover of the battery-powered unit, and
the hood-shaped cover is fastenable on the battery-bay housing in order to extend a length of the battery bay.

17. The battery-powered unit according to claim 1, wherein
once the axial portion has been snap-fitted, the arresting lever has a fixing position for fixing engagement on the received battery pack and a release position for releasing the fixing engagement, between which positions the arresting lever is pivotable about the pivot axis relative to the battery-bay housing, and
the arresting lever is spring-prestressed into the fixing position.

18. A system, comprising:
a battery-powered unit according to claim 1; and
the battery pack that is received in the battery bay in an interchangeable manner.

19. A method for assembling a battery-powered unit, comprising the steps of:
a) providing a battery-bay housing with a battery bay for receiving a battery pack in an interchangeable manner, which is connected to a snap-fit device which is fixed to the battery-bay housing;
b) providing an axial component portion, which carries an arresting lever that releasably fixes the battery pack;
c) placing the arresting lever on a placement surface that forms an assembly aid, and pre-positioning the axial component portion in a pre-positioning space defined by a counter-surface of the battery-powered unit located opposite the placement surface as seen in a direction transverse to the pivot axis, the pre-positioning space merges into a bearing space of the snap-fit device at a snap-fit aperture of the snap-fit device; and
d) pivoting the arresting lever, with actuating action, away from the placement surface, about the pivot axis, such that the axial portion is received, through the snap-fit aperture, into the bearing space, in order for the axial portion to be snap-fit.

20. The method according to claim 19,
wherein, at a point in time after step d) has been carried out, a stop device of the battery-powered unit, fastened on the battery-bay housing, blocks disengagement of the snap-fitted axial portion into the pre-positioning space.
